(19) United States
(12) Patent Application Publication
(10) Pub. No.: US 2004/0036811 A1
(43) Pub. Date: Feb. 26, 2004

(54) Broadcasting receiver and channel searching method in broadcasting receiver

(76) Inventor: Yasuyuki Ikeguchi, Itami City (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/642,185

(22) Filed: Aug. 18, 2003

(30) Foreign Application Priority Data
Aug. 22, 2002 (JP) 2002-242536

(51) Int. Cl. H04N 5/50

(52) U.S. Cl. 348/732; 725/38

(57) ABSTRACT

There are provided first channel searching means for sequentially tuning in to broadcasting channels using an analog broadcasting receiving unit, judging whether or not analog broadcasting is receivable for each of the broadcasting channels, and storing receivable channel information related to analog broadcasting in a channel map with respect to the broadcasting channel on which analog broadcasting is judged to be receivable, and second channel searching means for sequentially tuning in to the broadcasting channels excluding the broadcasting channel on which analog broadcasting is judged to be receivable by the first channel searching means using a digital broadcasting receiving unit, judging whether or not digital broadcasting is receivable for each of the broadcasting channels, and storing receivable channel information related to digital broadcasting in the channel map with respect to the broadcasting channel on which digital broadcasting is judged to be receivable.

### BACKGROUND OF THE INVENTION

1. Field of the Invention

The present invention relates to a broadcasting receiver comprising the function of receiving an analog television broadcasting signal and a ground wave digital television broadcasting signal and a channel searching method in the broadcasting receiver.

2. Description of the Prior Art

In recent years, ground wave digital television broadcasting has been developed. The transition from current analog broadcasting to digital broadcasting is being made. A period of the transition may include a time period during which both analog broadcasting and digital broadcasting are mixed. A television receiver requires a function capable of receiving both analog broadcasting and digital broadcasting. Therefore, a television receiver carrying both a tuner for receiving digital broadcasting and a tuner for receiving analog broadcasting has been developed.

In the period of the transition from analog broadcasting to digital broadcasting, it has been expected that a channel map is frequently changed as an analog station is abolished and a digital station is newly opened. Therefore, a receiver is required to make an efficient channel search.

On the other hand, in both analog broadcasting and digital broadcasting, smooth channel selection can be carried out by previously recognizing on which channel (frequency) broadcasting is being performed in the case of receiving, that is, on which channel broadcasting is receivable. Channels on which broadcasting is being performed differ for each area. Therefore, a channel map is produced by making a search (channel search) over all channels to determine on which channel and with which system (analog or digital broadcasting system) broadcasting is being performed when a receiver is installed.

The channel search is made by sequentially tuning in to channels with respect to each of a tuner for analog broadcasting and a tuner for digital broadcasting and judging whether or not broadcasting is being performed on the channel based on whether or not a normal signal to be received can be obtained from the tuner.

Description is now made of the conventional channel searching operation of a broadcasting receiver comprising the function of receiving both digital broadcasting and analog broadcasting using FIG. 1.

FIG. 1 illustrates the configuration of a broadcasting receiver comprising the function of receiving both digital broadcasting and analog broadcasting.

A microcomputer 300 receives, through a remote control signal receiver 301 for receiving an operation signal transmitted by radio from a remote control 401 or a main body operation key 302, the operation signal. The microcomputer 300 starts a channel searching operation by receiving an operation signal representing a channel search command.

The microcomputer 300 outputs to a digital tuner 101 a channel selection instruction for tuning in to a channel having the lowest frequency on which broadcasting may be performed when it receives the operation signal representing the channel search command. Out of signals inputted to the digital tuner 101 from a ground wave broadcasting antenna 100, the signal selected by the digital tuner 101 is inputted to a digital demodulator 102, and is subjected to demodulation processing conforming to a modulation system. Generally, a digital TV broadcasting signal is subjected to OFDM (Orthogonal Frequency Demodulation Multiplexing) modulation, for example, and is subjected to OFDM demodulation by the digital demodulator 102.

If a normal signal is broadcast, it is outputted as an MPEG (Motion Picture Expert Group) transport stream after being previously subjected to processing for error correction. The demodulated MPEG transport stream is subjected to decoding processing by a TS decoder 103, and is outputted as elementary streams such as a video, an audio, etc., so that a video signal and an audio signal are restored by a video/audio decoder 104.

The microcomputer 300 judges whether or not a normal digital signal is received on the channel which the digital tuner 101 is instructed to tune in to on the basis of the state of the digital demodulator 102. Specifically, it is judged whether or not the normal signal is broadcast depending on whether or not the digital demodulator 102 can establish synchronization of the received digital signal. However, a method of judging whether or not the normal digital signal is received is not necessarily limited to the same.

Information such as a broadcasting station name sent from a broadcasting station is acquired on the basis of data obtained by the TS decoder 103. The presence or absence of broadcasting may be judged depending on whether or not the broadcasting station name can be specified. When it is judged that the normal digital signal is received, the microcomputer 300 stores in a memory 303 information for channel selection (receivable channel information) such as a frequency, a broadcasting station name, and a channel number.

The microcomputer 300 then outputs an instruction to tune in to a channel on the high frequency side adjacent to the current channel, for example. The microcomputer 300 judges whether or not the normal digital signal is received on the channel tuned in to in the same manner as described above, and stores in the memory 303 information for channel selection (receivable channel information) such as a frequency, a broadcasting station name, and a channel number when it is judged that the normal digital signal is received. Such an operation is repeated over all channels, to store in the memory 303 receivable channel information indicating on which channel broadcasting is being performed.

A channel search for analog broadcasting is similarly made. That is, an instruction to tune in to a channel having the lowest frequency on which broadcasting may be performed from the microcomputer 300 to an analog tuner 201. Out of signals inputted to the analog tuner 201 from the ground wave broadcasting antenna 100, the signal selected by the analog tuner 201 is inputted to an analog demodulator 202, and is subjected to demodulation processing. The demodulated signal is outputted as a composite video signal or audio signal.

The demodulated analog composite video signal is inputted to a detector 203. The detector 203 outputs to the microcomputer 300 a judgment signal indicating whether or not a synchronizing signal can be detected from the video signal demodulated by the analog demodulator 202. The microcomputer 300 judges whether or not a normal video signal is demodulated on the basis of the judgment signal. The microcomputer 300 may judge whether or not the normal video signal is demodulated depending on whether or not a PLL (Phase Locked Loop) synchronizing circuit is locked (the tuner is locked). However, a method of judging whether or not the normal video signal is demodulated is not necessarily limited to the same.

The microcomputer 300 stores, when it judges that the normal video signal is demodulated, information for channel selection (receivable channel information) such as a channel frequency and a channel number in the memory 303, and outputs a channel selection instruction using the adjacent channel on the high frequency side as the subsequent channel. The same operation is repeated over all the channels, to store in the memory 303 receivable channel information indicating on which channel broadcasting is being performed.

At the time of a normal operation, the microcomputer 300 receives a channel selection instruction from a user through the remote control signal receiver 301 or the main body operation key 302, and refers to data in the memory 303, thereby outputting a channel selection instruction corresponding to the channel desired by the user to the digital tuner 101 or the analog tuner 201.

As described in the foregoing, in the channel search for digital broadcasting, it is judged whether or not a normal signal can be received, and it is necessary to confirm the contents of digital data in order to extract a broadcasting station name or the like. Therefore, it generally takes much time to judge whether or not broadcasting is being performed on the channel. Further, in Japanese ground wave digital broadcasting, there are a plurality of types of broadcasting modes, and all combinations of the modes must be tried. Therefore, it takes more time to make the judgment.

Thus, the channel search for digital broadcasting requires more time than the channel search for analog broadcasting. When a channel search must be frequently made as in a period of transition to digital broadcasting, a viewer is forced to feel inconvenience.

### SUMMARY OF THE INVENTION

An object of the present invention is to solve the above-mentioned problem and to provide a broadcasting receiver capable of efficiently making a channel search and a channel searching method in the broadcasting receiver.

In a broadcasting receiver comprising an analog broadcasting receiving unit for receiving an analog television broadcasting signal, a digital broadcasting receiving unit for receiving a digital television broadcasting signal, and a memory for storing a channel map storing receivable channel information such as the type of broadcasting for each of broadcasting channels, a broadcasting receiver according to the present invention is characterized by comprising first channel searching means for sequentially tuning in to the broadcasting channels using the analog broadcasting receiving unit, judging whether or not analog broadcasting is receivable for each of the broadcasting channels, and storing receivable channel information related to analog broadcasting in the channel map with respect to the broadcasting channel on which analog broadcasting is judged to be receivable; and second channel searching means for sequentially tuning in to the broadcasting channels excluding the broadcasting channel on which analog broadcasting is judged to be receivable by the first channel searching means using the digital broadcasting receiving unit, judging whether or not digital broadcasting is receivable for each of the broadcasting channels, and storing receivable channel information related to digital broadcasting in the channel map with respect to the broadcasting channel on which digital broadcasting is judged to be receivable.

Each of the first channel searching means and the second channel searching means obtains the results of judgment whether or not broadcasting is receivable for each of the broadcasting channels tuned in to, and records the receivable channel information in the channel map every time the results of the judgment for one of the broadcasting channels are obtained.

The second channel searching means refers to the channel map when a search for the given broadcasting channel is started, and omits, when the receivable channel information indicating that analog broadcasting is being performed on the broadcasting channel is stored in the channel map, the search for the broadcasting channel, to search for the subsequent broadcasting channel.

The broadcasting channels are searched for in the same order when the respective channel searches by the first channel searching means and the second channel searching means are simultaneously started, and the channel map is not referred to on the broadcasting channel which starts to be first searched for by the second channel searching means.

Each of the first channel searching means and the second channel searching means searches for the receivable broadcasting channels in ascending order of their frequencies, for example.

Each of the first channel searching means and the second channel searching means searches for the receivable broadcasting channels in descending order of their frequencies, for example.

The analog broadcasting receiving unit comprises an analog tuner for tuning in to a channel to be received and an analog demodulator for demodulating a signal on the channel tuned in to, and the first channel searching means Judges whether or not analog broadcasting is receivable depending on whether or not a horizontal synchronizing signal can be detected from a video signal demodulated by the analog demodulator, for example.

The digital broadcasting receiving unit comprises a digital tuner for tuning in to a channel to be received and a digital demodulator for demodulating a signal on the channel tuned in to, and the second channel searching means judges whether or not digital broadcasting is receivable depending on whether or not the digital demodulator can establish synchronization of a received signal, for example.

The digital broadcasting receiving unit comprises a digital tuner for tuning in to a channel to be received, a digital demodulator for demodulating a signal on the channel tuned in to, and a TS decoder for subjecting TS data obtained by the digital demodulator to separation processing, and the second channel searching means judges whether or not digital broadcasting is receivable depending on whether or not the broadcasting station can be recognized -from received data which has been subjected to decoding processing by the TS decoder, for example.

In a case where broadcasting is received for viewing or recording using one of the analog broadcasting receiving unit and the digital broadcasting receiving unit, the broadcasting receiving unit which is not used for viewing or recording may be operated for a channel search, to search for channels by the first channel searching means or the second channel searching means corresponding to the operated broadcasting receiving unit.

In a channel searching method in a broadcasting receiver comprising an analog broadcasting receiving unit for receiving an analog television broadcasting signal, a digital broadcasting receiving unit for receiving a digital television broadcasting signal, and a memory for storing a channel map storing receivable channel information such as the type of broadcasting for each of broadcasting channels, a channel searching method in a broadcasting receiver according to the present invention is characterized by comprising a first channel searching step for sequentially tuning in to the broadcasting channels using the analog broadcasting receiving unit, judging whether or not analog broadcasting is receivable for each of the broadcasting channels, and storing receivable channel information related to analog broadcasting in the channel map with respect to the broadcasting channel on which analog broadcasting is judged to be receivable; and a second channel searching step for sequentially tuning in to the broadcasting channels excluding the broadcasting channel on which analog broadcasting is judged to be receivable in the first channel searching step using the digital broadcasting receiving unit, judging whether or not digital broadcasting is receivable for each of the broadcasting channels, and storing receivable channel information related to digital broadcasting in the channel map with respect to the broadcasting channel on which digital broadcasting is judged to be receivable.

Each of the first channel searching step and the second channel searching step comprises the step of obtaining the results of judgment whether or not broadcasting is receivable for each of the broadcasting channels tuned in to, and recording the receivable channel information in the channel map every time the results of the judgment for one of the broadcasting channels are obtained.

The second channel searching step comprises the step of referring to the channel map when a search for the given broadcasting channel is started, and omitting, when the receivable channel information indicating that analog broadcasting is being performed on the broadcasting channel is stored in the channel map, the search for the broadcasting channel, to search for the subsequent broadcasting channel.

The broadcasting channels are searched for in the same order when the respective channel searches in the first channel searching step and the second channel searching step are simultaneously started, and the channel map is not referred to on the broadcasting channel which starts to be first searched for in the second channel searching step.

Each of the first channel searching step and the second channel searching step comprises the step of searching for the receivable broadcasting channels in ascending order of their frequencies, for example.

Each of the first channel searching step and the second channel searching step comprises the step of searching for the receivable broadcasting channels in descending order of their frequencies, for example.

The analog broadcasting receiving unit comprises an analog tuner for tuning in to a channel to be received and an analog demodulator for demodulating a signal on the channel tuned in to, and the first channel searching step comprises the step of judging whether or not analog broadcasting is receivable depending on whether or not a horizontal synchronizing signal can be detected from a video signal demodulated by the analog demodulator, for example.

The digital broadcasting receiving unit comprises a digital tuner for tuning in to a channel to be received and a digital demodulator for demodulating a signal on the channel tuned in to, and the second channel searching step comprises the step of judging whether or not digital broadcasting is receivable depending on whether or not the digital demodulator can establish synchronization of a received signal.

The digital broadcasting receiving unit comprises a digital tuner for tuning in to a channel to be received, a digital demodulator for demodulating a signal on the channel tuned in to, and a TS decoder for subjecting TS data obtained by the digital demodulator to separation processing, and the second channel searching step comprises the step of judging whether or not digital broadcasting is receivable depending on whether or not the broadcasting station can be recognized from received data which has been subjected to decoding processing by the TS decoder.

In a case where broadcasting is received for viewing or recording using one of the analog broadcasting receiving unit and the digital broadcasting receiving unit, the broadcasting receiving unit which is not used for viewing or recording may be operated for a channel search, to search for channels in the first channel searching step or the second channel searching step corresponding to the operated broadcasting receiving unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the configuration of a broadcasting receiver comprising the function of receiving both digital broadcasting and analog broadcasting;

FIG. 2 is a flow chart showing the procedure for channel searching processing for analog broadcasting;

FIG. 3 is a flow chart showing the procedure for channel searching processing for digital broadcasting;

FIG. 4a is a timing chart showing the timing of a conventional channel search; and

FIGS. 4b and 4c are timing charts showing the timing of a channel search according to the present invention.

### DESCRIPTION OF THE PREFERRED EMBODIMENTS

Referring now to the drawings, an embodiment of the present invention will be described.

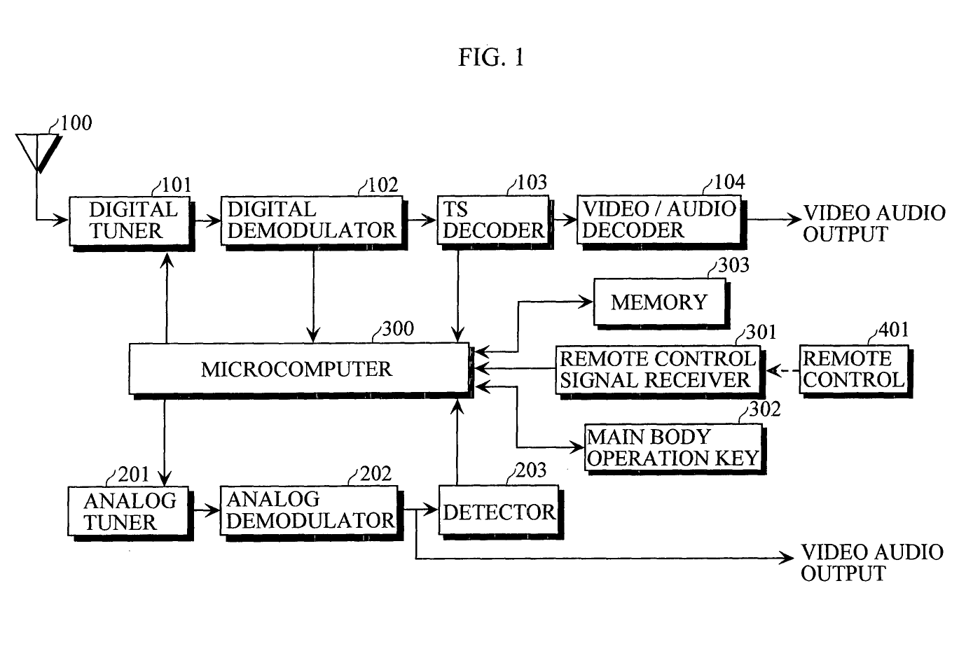

In the present embodiment, the configuration of a broadcasting receiver (a hardware configuration) is also the same as the configuration of the conventional broadcasting receiver shown in FIG. 1.

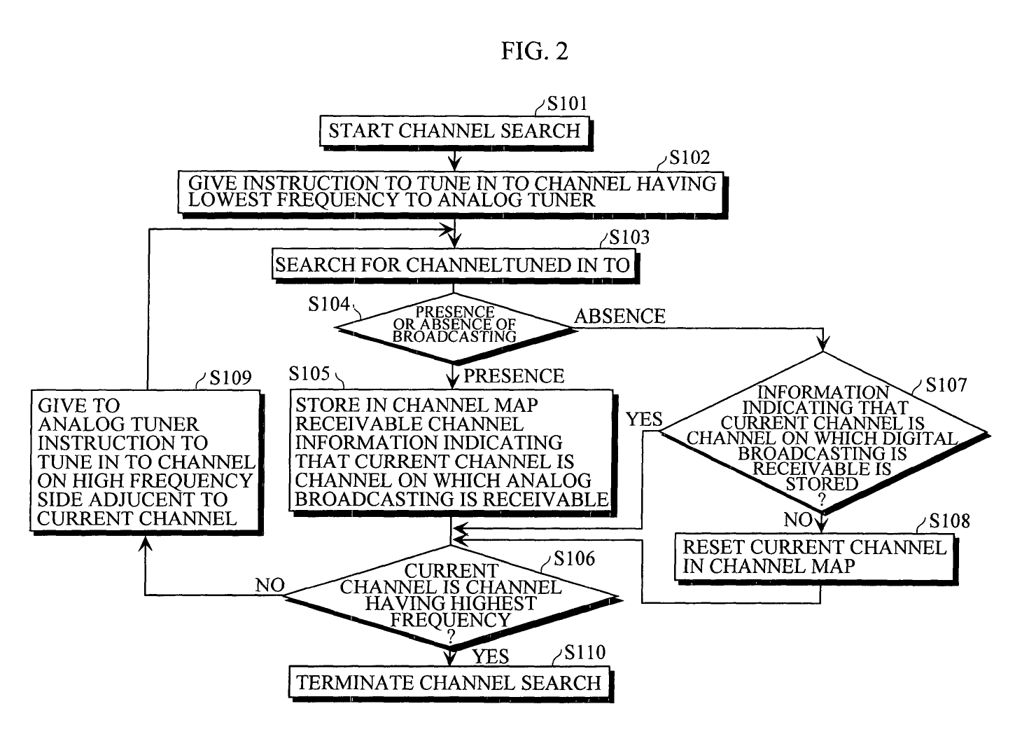

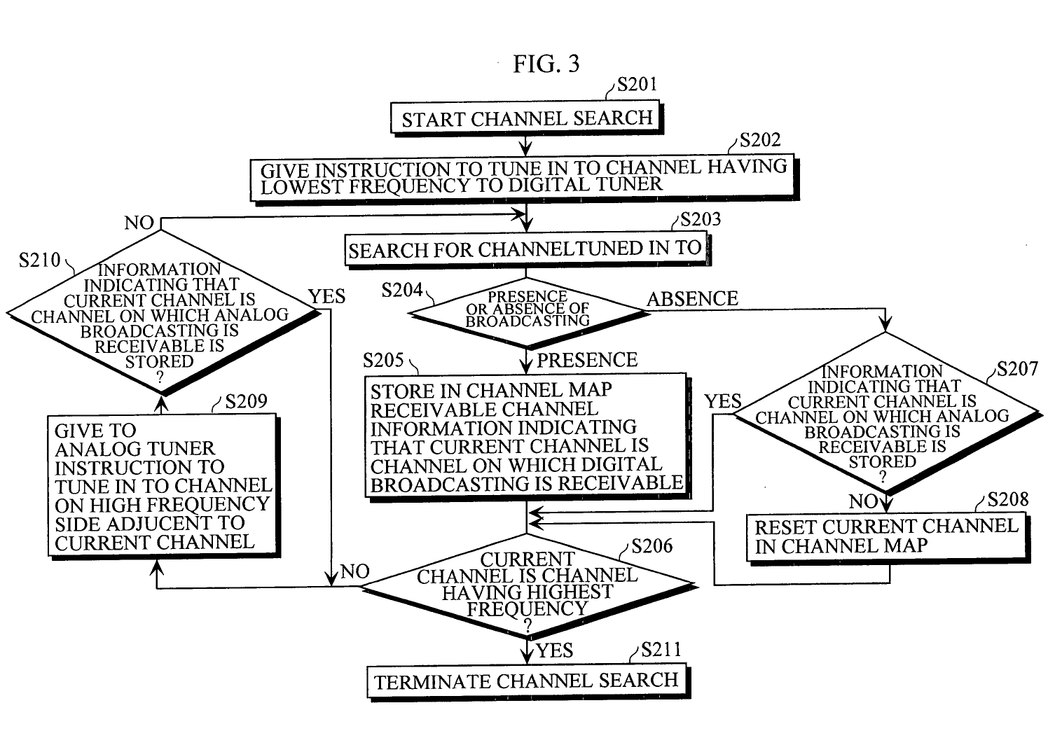

FIGS. 2 and 3 show the procedure for channel searching processing.

FIG. 2 shows the procedure for channel searching processing for analog broadcasting.

When a channel search is started (step S101), a microcomputer 300 gives an instruction to tune in to a receivable channel having the lowest frequency to an analog tuner 201 (step S102).

The analog tuner 201 selects a broadcasting signal corresponding to the channel which it is instructed to tune in to (step S103). The selected broadcasting signal is demodulated by an analog demodulator 202. At this time, it is judged whether or not there is broadcasting depending on whether or not a synchronizing signal can be detected from the demodulated broadcasting signal (step S104).

When there is broadcasting (when a synchronizing signal can be detected by a detector 203), the microcomputer 300 stores in a channel map inside a memory 303 receivable channel information indicating that a channel currently tuned in to is a channel on which analog broadcasting is receivable (step S105). The procedure proceeds to the step S106.

When it is judged in the foregoing step S104 that there is no broadcasting (no synchronizing signal is detected by the detector 203), the microcomputer 300 judges whether or not receivable channel information indicating whether or not the channel currently tuned in to in the channel map inside the memory 303 is a channel on which digital broadcasting is receivable is stored (step S107).

When the receivable channel information indicating that a channel currently tuned in to is a channel on which digital broadcasting is receivable is stored in the channel map, the microcomputer 300 does not rewrite data in the channel map, after which the procedure proceeds to the step S106. When the receivable channel information indicating that a channel currently tuned in to is a channel on which digital broadcasting is receivable is not stored in the channel map, the microcomputer 300 resets (erases) data related to the channel currently tuned in to in the channel map (step S108), after which the procedure proceeds to the step S106.

In the step S106, the microcomputer 300 judges whether or not a channel currently tuned in to is a receivable channel having the highest frequency. When the channel currently tuned in to is not a receivable channel having the highest frequency, the microcomputer 300 gives to the analog tuner 201 an instruction to tune in to a channel on the high frequency side adjacent to the channel currently tuned in to (step S109).

In the same manner as described above, a channel which the analog tuner 201 is newly instructed to tune in to is searched for (step S103), to judge whether or not there is broadcasting (step S104).

When all receivable channels are searched for in such a way, and a search for the receivable channel having the highest frequency is terminated, the answer is in the affirmative in the step S106, to terminate the channel search for analog broadcasting (step S110).

FIG. 3 shows the procedure for channel searching processing for digital broadcasting.

When a channel search is started (step S210), the microcomputer 300 gives an instruction to tune in to a receivable channel having the lowest frequency to the digital tuner 101 (step S202).

The digital tuner 101 selects a broadcasting signal corresponding to the channel which it is instructed to tune in to (step S203). The selected broadcasting signal is demodulated by the digital demodulator 102, and is subjected to data separation processing by a TS (Transport Stream) decoder 103. At this time, it is judged whether or not there is broadcasting depending on whether or not synchronization can be ensured and whether or not a broadcasting station can be recognized from output data from the TS decoder 103 by the status of the demodulator 102 (step S204).

When it is judged in the foregoing step S204 that there is broadcasting (synchronization can be ensured and a broadcasting station can be recognized), receivable channel information indicating that the current channel is one on which digital broadcasting is performed, which broadcasting station is performing broadcasting, and what modulation system is used, for example, is stored in the channel map inside the memory 303 (step S205). The procedure then proceeds to the step S206.

When it is judged in the foregoing step S204 that there is no broadcasting (no synchronization can be ensured or no broadcasting station can be recognized), it is judged whether or not receivable channel information indicating that a channel currently tuned in to is a channel on which analog broadcasting is receivable is stored in the channel map inside the memory 303 (step S207).

When the receivable channel information indicting that a channel currently tuned in to is a channel on which analog broadcasting is receivable is stored in the channel map, the microcomputer 300 does not rewrite data an the channel map, after which the procedure proceeds to the step S206. When the receivable channel information indicting that a channel currently tuned in to is a channel on which analog broadcasting is receivable is not stored in the channel map, the microcomputer 300 resets (erases) data related to the channel currently tuned in to in the channel map (step S208), after which the procedure proceeds to the step S206.

In the step S206, the microcomputer 300 judges whether or not a channel currently tuned in to is a receivable channel having the highest frequency. When the channel currently tuned in to is not a receivable channel having the highest frequency, the microcomputer 300 gives to the digital tuner 101 an instruction to tune in to a channel on the high frequency side adjacent to the channel currently tuned in to (step S209)

It is judged whether or not receivable channel information indicating that a channel which the digital tuner 101 is newly instructed to tune in to is a channel on which analog broadcasting is receivable is stored in the channel map (step S210).

When the receivable channel information indicating that a channel which the digital tuner 101 is newly instructed to tune in to is a channel on which analog broadcasting is receivable is stored in the channel map, it is found that the channel has already been recognized as a channel on which analog broadcasting is receivable. Therefore, the microcomputer 300 does not search for the channel but gives to the digital tuner 101 an instruction to tune in to a channel on the high frequency side adjacent to the channel currently tuned in to (step S209).

When in the foregoing step S210, the receivable channel information indicating that a channel which the digital tuner 101 is newly instructed to tune in to is a channel on which analog broadcasting is receivable is not stored in the channel map, the channel is searched for in the same manner as described above (step S203), to confirm the presence or absence of broadcasting (step S204).

When all receivable channels are searched for in such a way, and a search for the receivable channel having the highest frequency is terminated, the answer is in the affirmative in the step S206, to terminate the channel search for analog broadcasting (step S110).

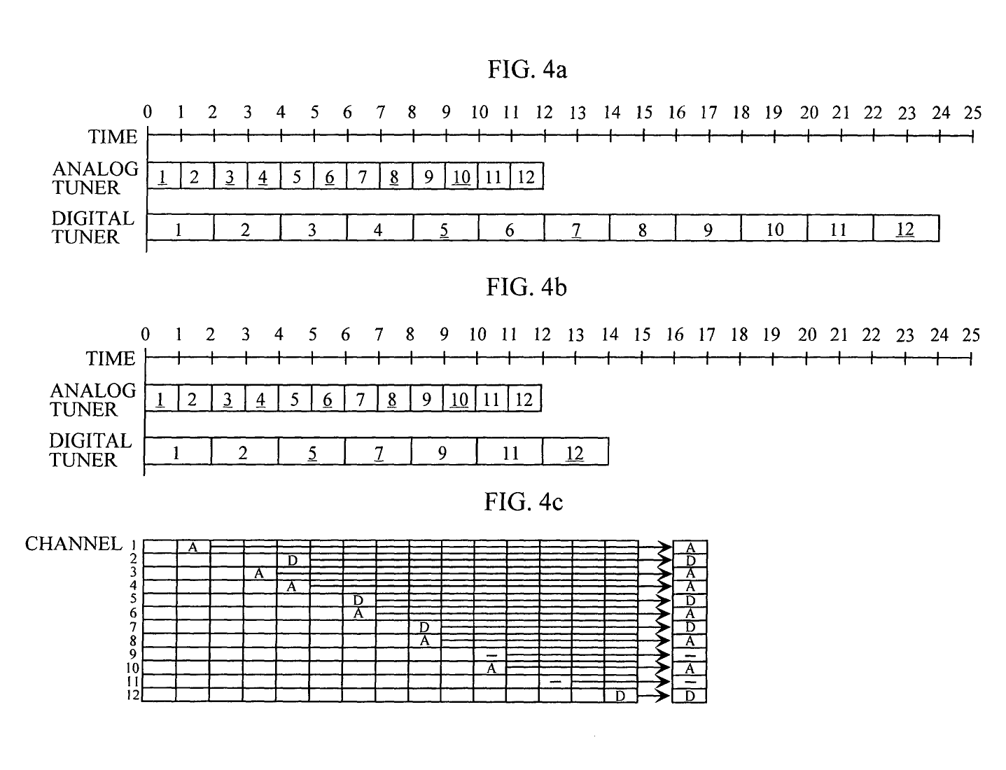

Furthermore, channel searching processing will be specifically described using FIGS. 4a, 4b, and 4c. For simplicity, description is made using an example in which a search is made between Channel 1 and Channel 12. It is herein assumed that analog broadcasting and digital broadcasting are mixed, analog broadcasting is performed on each of Channels 1, 3, 4, 6, 8, and 10, and digital broadcasting is performed on each of Channels 2, 5, 7, and 12. Further, in this example, it is assumed that a channel search for analog broadcasting and a channel search for digital broadcasting are simultaneously started.

Description is now made of an initial channel search for resetting a channel map and producing channel map data from the beginning. When a user designates a channel search, the initial channel search is made.

The horizontal axis in FIGS. 4a, 4b, and 4c represents time, and indicates how a search for each of channels proceeds. It is herein assumed that the judgment of the presence or absence of analog broadcasting requires one unit time period (e.g., one second) per channel, and the judgment of the presence or absence of digital broadcasting requires two unit time periods per channel.

FIG. 4a illustrates a case where a channel search is made by the conventional method. FIG. 4a illustrates a channel search for analog broadcasting by the analog tuner 201 and a channel search for digital broadcasting by the digital tuner 101. A numeral in a square represents the number of a channel which is being searched for. An underlined number indicates that the broadcasting is being performed on the channel. In the conventional example, even if the channel search for analog broadcasting and the channel search for digital broadcasting are simultaneously made, the searches are individually made. It takes longer to make a judgment in the channel search for digital broadcasting. Accordingly, it takes 24 unit time periods from time “0” to time “24” to search for Channels 1 to 12.

On the other hand, FIG. 4b illustrates a channel search according to the present invention. FIG. 4b also illustrates a channel search for analog broadcasting by the analog tuner 201 and a channel search for digital broadcasting by the digital tuner 101. As in FIG. 4a, a numeral in a square represents the number of a channel which is being searched for.

FIG. 4c illustrates situations where the acquisition of channel map data proceeds at each time, where “A” indicates that analog broadcasting is being performed, and “D” indicates that digital broadcasting is being performed. A blank column indicates that a search is unfinished, and “-” indicates that neither analog broadcasting nor digital broadcasting is being performed.

Description is now made of the procedure for channel searching processing using FIGS. 4b and 4c.

First, a search for analog broadcasting (hereinafter referred to as an analog search) and a search for digital broadcasting (hereinafter referred to as a digital search) are simultaneously started on Channel 1 at time “0”.

At time “1”, it is judged that analog broadcasting is being performed on Channel 1 by the analog search, and “A” indicating that analog broadcasting is being performed is recorded in a column of Channel 1 in the channel map.

In the analog search, the transition to a search for the subsequent Channel 2 occurs. In the digital search, the search for Channel 1 is being continued.

At time “2”, it is judged that analog broadcasting is not being performed on Channel 2 by the analog search. Since the results of judgment on a digital search for Channel 2 have not been obtained yet, however, a column of Channel 2 in the channel map remains blank.

In the analog search, the transition to a search for the subsequent Channel 3 occurs. Judgment on Channel 1 by the digital search is terminated, so that it is judged that digital broadcasting is not being performed on Channel 1. Since “A” has already been recorded in the column of Channel 1 in the channel map, the column of Channel 1 in the channel map remains unchanged.

In the case of the transition to a digital search for the subsequent Channel 2, the column of Channel 2 in the channel map is confirmed. Since the column of Channel 2 in the channel map is a blank column, the digital search for Channel 2 is started.

At time “3”, it is judged that analog broadcasting is being performed on Channel 3 by the analog search, and “An is recorded in a column of Channel 3 in the channel map. In the analog search, the transition to a search for the subsequent Channel 4 occurs. In the digital search, the search for Channel 2 is being continued.

At time “4”, it is judged that analog broadcasting is being performed on Channel 4 by the analog search, and “A” is recorded in a column of Channel 4 in the channel map. In the analog search, the transition to a search for the subsequent Channel 5 occurs. Judgment on Channel 2 by the digital search is terminated, so that it is judged that digital broadcasting is being performed. Consequently, “D” meaning that digital broadcasting is being performed is recorded in the column of Channel 2 in the channel map and at the same time, channel information such as a broadcasting station name is also stored.

In the case of the transition to a digital search for the subsequent Channel 3, the column of Channel 3 in the channel map is confirmed. Since “A” is recorded in the column of Channel 3 in the channel map, the digital search for Channel 3 is not made, to confirm the column of Channel 4 in the channel map. Since “A” is also recorded in the column of Channel 4 in the channel map, a digital search for Channel 4 is not made, to confirm a column of Channel 5 in the channel map. Since the column of Channel 5 in the channel map is a blank column, a digital search for Channel 5 is started.

At time “5”, it is judged that analog broadcasting is not being performed on Channel 5 by the analog search. Consequently, the column of Channel 5 in the channel map remains blank. In the analog search, the transition to a search for the subsequent Channel 6 occurs. In the digital search, the search for Channel 5 is being continued.

At time “6”, it is judged that analog broadcasting is being performed on Channel 6 by the analog search, and “A” is recorded in a column of Channel 6 in the channel map. In the analog search, the transition to a search for the subsequent Channel 7 occurs. In the digital search, judgment on Channel 5 is terminated, so that it is judged that digital broadcasting is being performed. Consequently, “D” is recorded in the column of Channel 5 in the channel map and at the same time, channel information such as a broadcasting station name is recorded. In the case of the transition to a digital search for the subsequent channel, the next column in the channel map is confirmed. Since “A” has already been recorded in the column of Channel 6, a digital search for Channel 6 is not made, to start a digital search for the subsequent Channel 7.

At time “7”, it is judged that analog broadcasting is not being performed on Channel 7 by the analog search. Consequently, a column of Channel 7 in the channel map remains blank. In the analog search, the transition to a search for the subsequent Channel 8 occurs. In the digital search, the search for Channel 7 is being continued.

At time “8”, it is judged that analog broadcasting is being performed on Channel 8 by the analog search, and “A” is recorded in a column of Channel 8 in the channel map. In the analog search, the transition to a search for the subsequent Channel 9 occurs. In the digital search, the search for Channel 7 is terminated, so that it is judged that digital broadcasting is being performed on Channel 7. Consequently, “D” is recorded in the column of Channel 7 in the channel map, and channel information such as a broadcasting station name is recorded. In the case of the transition to a digital search for the subsequent channel, the next column in the channel map is confirmed. Since “A” has already been recorded in the column of Channel 8, a digital search for Channel 8 is not made, to start a digital search for the subsequent Channel 9.

At time “9”, it is judged that analog broadcasting is not being performed on Channel 9 by the analog search. Consequently, a column of Channel 9 in the channel map remains blank. In the analog search, the transition to a search for the subsequent Channel 10 occurs. In the digital search, the search for Channel 9 is being continued.

At time “10”, it is judged that analog broadcasting is being performed on Channel 10 by the analog search, and “A” is recorded in a column of Channel 10 in the channel map. In the analog search, the transition to a search for the subsequent Channel 11 occurs. In the digital search, the search for Channel 9 is terminated, so that it is judged that digital broadcasting is not being performed on Channel 9. Since the column of Channel 9 in the channel map is a blank column, “-” meaning that there is no station is recorded in the column. In the case of the transition to a digital search for the subsequent channel, the next column in the channel map is confirmed. Since “A” has already been recorded in the column of Channel 10, a digital search for Channel 10 is not made, to start a digital search for the subsequent Channel 11.

At time “11”, it is judged that analog broadcasting is not being performed on Channel 11 by the analog search. Consequently, a column of Channel 11 in the channel map remains blank.

In the analog search, the transition to a search for the subsequent Channel 12 occurs. In the digital search, the search for Channel 11 is being continued.

At time “12”, it is judged that analog broadcasting is not being performed on Channel 12 by the analog search. Consequently, a column of Channel 12 in the channel map remains blank. Consequently, the analog search is terminated.

The digital search for Channel 11 is terminated, so that it is judged that digital broadcasting is not being performed on Channel 11. Since the column of Channel 11 in the channel map is a blank column, “-” meaning that there is no station is recorded in the column. In the case of the transition to digital judgment on the subsequent channel, the next column in the channel map is confirmed. Since the column of Channel 12 in the channel map is a blank column, a digital search for Channel 12 is started.

At time “13”, the analog search has been terminated. In the digital search, the search for Channel 12 is being continued.

At time “14”, the digital search for Channel 12 is terminated, so that it is judged that digital broadcasting is being performed on Channel 12. Consequently, “D” is recorded in the column of Channel 12 in the channel map, and channel information such as a broadcasting station name is recorded therein. Consequently, the digital search is terminated.

In this stage, the final channel map is completed. The completion of the channel map requires 14 unit time periods, which are made shorter than 24 unit time periods in the conventional method. Although description was herein made, assuming that the ratio of a time period required to judge the presence or absence of analog broadcasting to a time period required to judge the presence or absence of digital broadcasting is 1:2, an overall shortening effect is further increased in a case where it takes longer to judge digital broadcasting than analog broadcasting.

When only a digital search for digital broadcasting is made in order to newly add digital broadcasting, a search time period can be similarly shortened by referring to a channel map which is already completed, to attempt to search for only channels other than a channel on which analog broadcasting is being performed.

When either of the types of broadcasting is being viewed, a channel search is made using a tuner for the other type of broadcasting, thereby making it possible to also update the channel map. Specifically, while digital broadcasting is being received, an analog search is made, to update data related to an analog channel. When a channel on which it is judged that there is no analog broadcasting, as judged in the step S107 shown in FIG. 2, has already been stored as one on which digital broadcasting is performed on the channel map, data related to the channel is not updated.

On the other hand, while analog broadcasting is being viewed, a digital search is made, thereby making it possible to also update data related to a digital channel. The results of an analog search are given priority to, as judged in the steps S207 and S209 shown in FIG. 3, to neither make a digital search nor update data with respect to a channel which has been stored as one on which analog broadcasting is performed on the channel map.

As described in the foregoing, the digital search requires more time than the analog search. In both cases where both the digital search and the analog search are simultaneously and separately made, therefore, the results of the analog search are given priority to and reflected on digital searching processing to omit the digital search for a channel on which it is found that analog broadcasting is performed, thereby making it possible to shorten a time period required to make the whole channel search. Although in the above-mentioned embodiment, an example in which channels are searched for in ascending order of their frequencies, the present invention is not limited to the same. For example, the channels may be searched for in descending order of their frequencies.

Furthermore, the order of channels to be searched for is not limited to those in the above-mentioned examples. Consequently, the channel search may not be started on the highest-numbered channel or the lowest-numbered channel but may be started on the channels therebetween. For example, the order is Channels 6, 7, 8, 9, 10, 11, 12, 1, 2, 3, 4, and 5. Further, the order of channels to be searched for may not be the order of channel numbers. That is, if the respective orders of channels to be searched for in analog broadcasting and digital broadcasting are the same, the orders may be in any form.

According to the above-mentioned embodiment, the channel search for digital broadcasting is not made with respect to the channel on which it is judged that analog broadcasting exists. Therefore, a channel search time period can be shortened.

Although the present invention has been described and illustrated in detail, it is clearly understood that the same is by way of illustration and example only and is not to be taken by way of limitation, the spirit and scope of the present invention being limited only by the terms of the appended claims.

What is claimed

1. In a broadcasting receiver comprising an analog broadcasting receiving unit for receiving an analog television broadcasting signal, a digital broadcasting receiving unit for receiving a digital television broadcasting signal, and a memory for storing a channel map storing receivable channel information such as the type of broadcasting for each of broadcasting channels,
a broadcasting receiver comprising:
first channel searching means for sequentially tuning in to the broadcasting channels using the analog broadcasting receiving unit, judging whether or not analog broadcasting is receivable for each of the broadcasting channels, and storing receivable channel information related to analog broadcasting in the channel map with respect to the broadcasting channel on which analog broadcasting is judged to be receivable; and
second channel searching means for sequentially tuning in to the broadcasting channels excluding the broadcasting channel on which analog broadcasting is judged to be receivable by the first channel searching means using the digital broadcasting receiving unit, judging whether or not digital broadcasting is receivable for each of the broadcasting channels, and storing receivable channel information related to digital broadcasting in the channel map with respect to the broadcasting channel on which digital broadcasting is judged to be receivable.

2. The broadcasting receiver according to claim 1, wherein
each of said first channel searching means and said second channel searching means obtains the results of judgment whether or not broadcasting is receivable for each of the broadcasting channels tuned in to, and records the receivable channel information in the channel map every time the results of the judgment for one of the broadcasting channels are obtained.

3. The broadcasting receiver according to claim 2, wherein
said second channel searching means refers to the channel map when a search for the given broadcasting channel is started, and omits, when the receivable channel information indicating that analog broadcasting is being performed on the broadcasting channel is stored in the channel map, the search for the broadcasting channel, to search for the subsequent broadcasting channel.

4. The broadcasting receiver according to claim 3, wherein
the broadcasting channels are searched for in the same order when the respective channel searches by said first channel searching means and said second channel searching means are simultaneously started, and
said channel map is not referred to on the broadcasting channel which starts to be first searched for by said second channel searching means.

5. The broadcasting receiver according to claim 1, wherein
each of said first channel searching means and said second channel searching means searches for the receivable broadcasting channels in ascending order of their frequencies.

6. The broadcasting receiver according to claim 1, wherein
each of said first channel searching means and said second channel searching means searches for the receivable broadcasting channels in descending order of their frequencies.

7. The broadcasting receiver according to claim 1, wherein
said analog broadcasting receiving unit comprises an analog tuner for tuning in to a channel to be received and an analog demodulator for demodulating a signal on the channel tuned in to, and
the first channel searching means judges whether or not analog broadcasting is receivable depending on whether or not a horizontal synchronizing signal can be detected from a video signal demodulated by the analog demodulator.

8. The broadcasting receiver according to claim 1, wherein
said digital broadcasting receiving unit comprises a digital tuner for tuning in to a channel to be received and a digital demodulator for demodulating a signal on the channel tuned in to, and
the second channel searching means judges whether or not digital broadcasting is receivable depending on whether or not the digital demodulator can establish synchronization of a received signal.

9. The broadcasting receiver according to claim 1, wherein
said digital broadcasting receiving unit comprises a digital tuner for tuning in to a channel to be received, a digital demodulator for demodulating a signal on the channel tuned in to, and a TS (Transport Stream) decoder for subjecting TS data obtained by the digital demodulator to separation processing, and
the second channel searching means judges whether or not digital broadcasting is receivable depending on whether or not the broadcasting station can be recognized from received data which has been subjected to decoding processing by the TS decoder.

10. The broadcasting receiver according to claim 1, wherein
in a case where broadcasting is received for viewing or recording using one of said analog broadcasting receiving unit and said digital broadcasting receiving unit, the broadcasting receiving unit which is not used for viewing or recording is operated for a channel search, to search for channels by said first channel searching means or said second channel searching means corresponding to the operated broadcasting receiving unit.

11. In a channel searching method in a broadcasting receiver comprising an analog broadcasting receiving unit for receiving an analog television broadcasting signal, a digital broadcasting receiving unit for receiving a digital television broadcasting signal, and a memory for storing a channel map storing receivable channel information such as the type of broadcasting for each of broadcasting channels,
a channel searching method comprising:
a first channel searching step for sequentially tuning in to the broadcasting channels using the analog broadcasting receiving unit, judging whether or not analog broadcasting is receivable for each of the broadcasting channels, and storing receivable channel information related to analog broadcasting in the channel map with respect to the broadcasting channel on which analog broadcasting is judged to be receivable; and
a second channel searching step for sequentially tuning in to the broadcasting channels excluding the broadcasting channel on which analog broadcasting is judged to be receivable in the first channel searching step using the digital broadcasting receiving unit, judging whether or not digital broadcasting is receivable for each of the broadcasting channels, and storing receivable channel information related to digital broadcasting in the channel map with respect to the broadcasting channel on which digital broadcasting is judged to be receivable.

12. The channel searching method according to claim 11, wherein
each of said first channel searching step and said second channel searching step comprises the step of obtaining the results of judgment whether or not broadcasting is receivable for each of the broadcasting channels tuned in to, and recording the receivable channel information in the channel map every time the results of the judgment for one of the broadcasting channels are obtained.

13. The channel searching method according to claim 12, wherein
said second channel searching step comprises the step of referring to the channel map when a search for the given broadcasting channel is started, and omitting, when the receivable channel information indicating that analog broadcasting is being performed on the broadcasting channel is stored in the channel map, the search for the broadcasting channel, to search for the subsequent broadcasting channel.

14. The channel searching method according to claim 13, wherein
the broadcasting channels are searched for in the same order when the respective channel searches in said first channel searching step and said second channel searching step are simultaneously started, and
said channel map is not referred to on the broadcasting channel which starts to be first searched for in said second channel searching step.

15. The channel searching method according to claim 11, wherein
each of said first channel searching step and said second channel searching step comprises the step of searching for the receivable broadcasting channels in ascending order of their frequencies.

16. The channel searching method according to claim 11, wherein
each of said first channel searching step and said second channel searching step comprises the step of searching for the receivable broadcasting channels in descending order of their frequencies.

17. The channel searching method according to claim 11, wherein
said analog broadcasting receiving unit comprises an analog tuner for tuning in to a channel to be received and an analog demodulator for demodulating a signal on the channel tuned in to, and
the first channel searching step comprises the step of judging whether or not analog broadcasting is receivable depending on whether or not a horizontal synchronizing signal can be detected from a video signal demodulated by the analog demodulator.

18. The channel searching method according to claim 11, wherein
said digital broadcasting receiving unit comprises a digital tuner for tuning in to a channel to be received and a digital demodulator for demodulating a signal on the channel tuned in to, and
the second channel searching step comprises the step of judging whether or not digital broadcasting is receivable depending on whether or not the digital demodulator can establish synchronization of a received signal.

19. The channel searching method according to claim 11, wherein
said digital broadcasting receiving unit comprises a digital tuner for tuning in to a channel to be received, a digital demodulator for demodulating a signal on the channel tuned in to, and a TS decoder for subjecting TS data obtained by the digital demodulator to separation processing, and
the second channel searching step comprises the step of judging whether or not digital broadcasting is receivable depending on whether or not the broadcasting station can be recognized from received data which has been subjected to decoding processing by the TS decoder.

20. The channel searching method according to claim 11, wherein
in a case where broadcasting is received for viewing or recording using one of said analog broadcasting receiving unit and said digital broadcasting receiving unit, the broadcasting receiving unit which is not used for viewing or recording is operated for a channel search, to search for channels in said first channel searching step or said second channel searching step corresponding to the operated broadcasting receiving unit.
